(19) United States
(12) Patent Application Publication
(10) Pub. No.: US 2007/0125250 A1
(43) Pub. Date: Jun. 7, 2007

(54) Printing cylinder for a rotary web press and method for operating a rotary web press

(75) Inventors: Dirk Probian, Gablingen/Luetzelburg (DE); Peer Dilling, Friedberg (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 11/605,902

(22) Filed: Nov. 29, 2006

(30) Foreign Application Priority Data
Nov. 30, 2005 (DE) 10 2005 056 980.3

(51) Int. Cl. B41F 13/10

(52) U.S. Cl. 101/375

(57) ABSTRACT

A printing cylinder for a rotary web press to which at least one printing form is attached and a method for operating a rotary web press is disclosed. The printing cylinder is built up of at least one cylinder core and an adapter sleeve installed thereon, wherein the adapter sleeve is configured in such a way that either printing forms in the shape of sleeves or printing plates can be attached thereto before the printing process, depending on the size of the print run.

This application claims the priority of German Patent Document No. 10 2005 056 980.3, filed Nov. 30, 2005, the disclosure of which is expressly incorporated by reference herein.

### BACKGROUND AND SUMMARY OF THE INVENTION

The invention relates to a printing cylinder for a rotary web press on which at least one printing form has been installed. The invention further relates to a method for operating a rotary web press.

In known printing presses, printing or plate cylinders with clamping systems are used in the printing units to clamp appropriate printing forms on this printing or plate cylinder. In the case of the printing forms, they are predominantly disposable plates which are customarily produced off-press in a plate setter. Such disposable printing plates, on which the print image is usually baked, are used mostly in very high print runs. After printing, these disposable printing plates are thrown away.

In the area of digital printing, for example the DICOWEB of the applicant, it is known to use printing or plate cylinders in the printing unit which use sleeves in place of the printing plates and thus to function without traditional plate clamping or clamping mechanisms. In digital presses, the sleeves are installed onto the printing or plate cylinder with the assistance of an air cushion. Printing form costs represent an increasingly dominant portion of production costs, particularly with small print runs. An imaging procedure is known especially for the DICOWEB (digital press) of the applicant which makes it possible to produce printing forms for smaller print runs more economically. However, because of the erase cycle which follows the printing process, the potential size of the print run is limited. The manufacturing process for these printing forms can be carried out both in-press and off-press.

The object for the inventors was to improve a rotary web press, independently of whether it operates with digital in-press imaging or with a conventional plate.

The inventors recognized that it is possible to use conventional printing plates as well as sleeves on a modified printing cylinder of a press and thus to install the most suitable and economical printing form on the printing cylinder or plate cylinder without taking great conversion measures.

From the knowledge thus gained, the inventors provide an improved printing cylinder for a rotary web press, on which at least one printing form has been installed, to the effect that the printing cylinder consists of at least one cylinder core and an adapter sleeve installed thereon, wherein the adapter sleeve is configured such that either printing forms in the shape of sleeves or printing plates can be attached thereto.

As a result, it is possible for the printing press operator to use the economical alternative for the particular size of print run without taking great conversion measures. In this way, the proportionately low-priced directly imaged sleeves can be used for single print orders, while the correspondingly economical disposable plate is used for the large run portion. The invention makes it possible to use sleeves either as endless sleeves or as sleeves with a welded seam.

As an alternative, or as a supplement to this, conventional printing plates with bevels can also be used which are fixed in lock-up slots on the adapter sleeves. The adapter sleeve can be implemented optionally without a lock-up slot or with at least one lock-up slot.

In the embodiment without a lock-up slot, this adapter sleeve is suitable for sleeves. In the embodiment with at least one lock-up slot it is preferably suitable for printing plates. It is advantageous on adapter sleeves if several such lock-up slots are disposed thereon. They can preferably be located offset to each other relative to the circumference of the adapter sleeve.

The offset of the lock-up slots on the circumference of the adapter sleeve can be 90°, 120° or even 180°. With the lock-up slots offset to each other at 90°, four lock-up slots can, for example, be incorporated on the cylinder around the circumference of the printing cylinder. However, it can also be fewer than four lock-up slots or more than four lock-up slots on the printing cylinder with a 90° offset.

With a 120 degree-offset for the lock-up slots on the circumference of the printing cylinder, ideally three lock-up slots and thus three printing plates can be disposed equally spaced around the circumference of the printing cylinder. However, in this case also, fewer or more in the number of lock-up slots can be disposed relative to the circumference of the printing cylinder which include a 120 degree-offset.

In order to save weight in the area of the printing cylinder, it is advantageous if the adapter sleeve consists of a metal foam and/or a plastic foam.

In addition to the printing cylinder for a rotary web press, the inventors also provide a new method for operating a rotary web press. The new method is that the printing cylinder consists of at least one cylinder core and an adapter sleeve, wherein the adapter sleeve is installed on this cylinder core and is configured such that printing forms in the shape of sleeves or printing plates can be attached to the adapter sleeve, where either sleeves or printing plates are attached to the adapter sleeve before the printing process, depending on the size of the print run.

In the new method, imaging the printing forms is envisaged either inside or outside the printing press as an option. Imaging the printing forms inside the press results in an enormous savings in time.

Preferred developments of the invention will become clear from the following description.

### BRIEF DESCRIPTION OF THE DRAWINGS

Different embodiments of the invention will be explained in more detail with reference to the drawings, without being limited to them.

FIG. 1 shows a view of an end face of an adapter sleeve with an endless sleeve installed;

FIG. 2 shows a view of an end face of an adapter sleeve with a welded sleeve installed;

FIG. 3 shows a sectional view of a printing cylinder structure along the longitudinal axis of the cylinder;

FIG. 4 shows a view of an end face of a further embodiment of an adapter sleeve; and

FIG. 5 shows a view of an end face of an adapter sleeve with a lock-up slot.

### DETAILED DESCRIPTION OF THE DRAWINGS

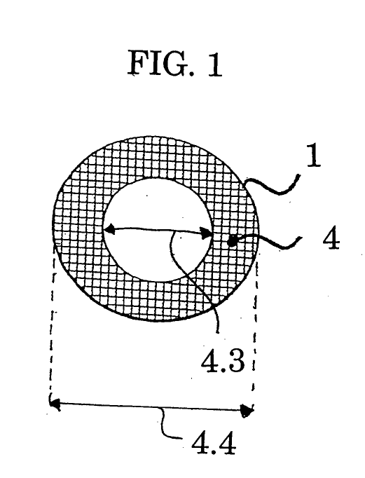

Embodiments of the present invention are described with reference to FIGS. 1 to 5.

FIG. 1 shows a view onto an end face of an adapter sleeve 4 with an endless sleeve 1 installed. The adapter sleeve 4 is pushed onto the cylinder core of the new printing cylinder with its inside diameter 4.3. By adjusting the outside diameter 4.4 of the adapter sleeve 4, the print format can be adjusted. Both inside diameter 4.3 and outside diameter 4.4 of the adapter sleeve 4 can be matched to the cylinder core and the print format.

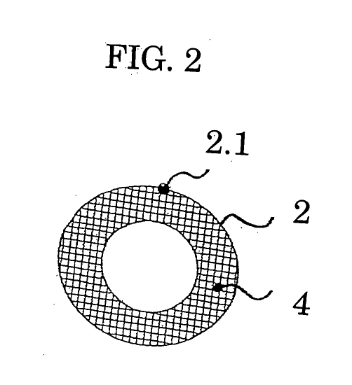

FIG. 2 shows the adapter sleeve 4 from FIG. 1, onto which a welded sleeve 2 has been pulled. In the upper part of the adapter sleeve the weld seam 2.1 of the sleeve is indicated by a dot.

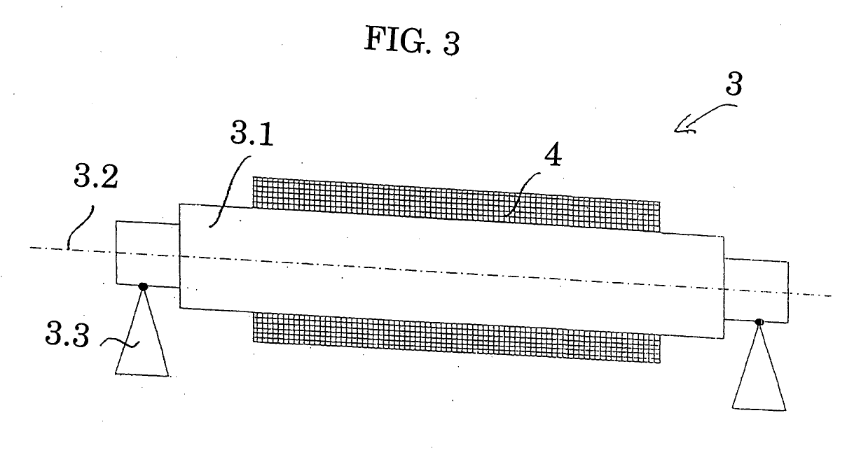

FIG. 3 shows a sectioned view of the new printing cylinder construction along the longitudinal axis of the cylinder. The printing cylinder 3, which rotates about the axis of rotation 3.2, is carried on both sides in a printing press by a bearing 3.3. The structure of the printing cylinder consists of a cylinder core 3.1 onto the outer surface of which the adapter sleeve is pushed. In turn, either a sleeve can be attached to the adapter sleeve or the adapter sleeve 4 is configured such that one or more conventional printing plates can be attached. The adapter sleeve can, for example, be made to receive sleeves without a lock-up slot and to receive printing plates with plate lock-up slot(s).

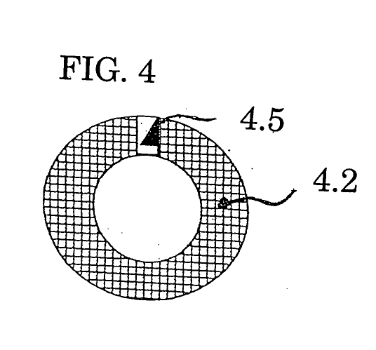

FIG. 4 shows an adapter sleeve 4.2 on which the printing plates are clamped with the help of centrifugal force which is created as the printing cylinder rotates. The expanding wedge 4.5, against the side surfaces of which the bevels of the printing plate lie, is pressed to the outer area of the jacket as the printing cylinder rotates and thus holds the printing plate tight.

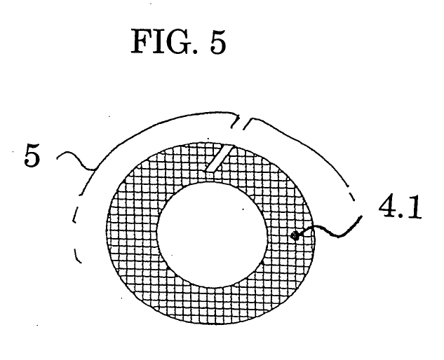

FIG. 5 shows a view onto an end face of an adapter sleeve 4.1 with a lock-up slot. The printing plate 5 can be attached in the lock-up slot on the upper side of the adapter sleeve 4.1.

It goes without saying that the previously named features and the features of the claims can be used not only in the particular combinations given but also in other combinations or standing alone within the scope of the invention.

### LIST OF REFERENCE NUMERALS

1. Endless sleeve
2. Welded sleeve
2.1 Weld seam
3. Printing cylinder
3.1 Cylinder core
3.2 Axis of rotation
3.3 Bearing
4. Adapter sleeve
4.1 Adapter sleeve with clamping slot
4.2. Adapter sleeve with centrifugal clamping
4.3 Inside diameter of the adapter sleeve
4.4 Outside diameter of the adapter sleeve
4.5 Expanding wedge
5. Printing plate

As discussed above, the foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing cylinder for a rotary web press onto which at least one printing form is installed, wherein the printing cylinder consists of at least one cylinder core and an adapter sleeve attached thereto, wherein the adapter sleeve is configured in such a way that either a printing form in a shape of a sleeve or a printing plate can be attached thereto.

2. The printing cylinder according to claim 1, wherein the sleeve is either an endless sleeve or a sleeve with a welded seam.

3. The printing cylinder according to claim 1, wherein the printing plate has bevels with which they are attached in lock-up slots in the adapter sleeve.

4. The printing cylinder according to claim 1, wherein the adapter sleeve includes a lock-up slot.

5. The printing cylinder according to claim 1, wherein the adapter sleeve does not include a lock-up slot.

6. The printing cylinder according to claim 4, wherein the adapter sleeve includes a plurality of lock-up slots and wherein the lock-up slots are disposed thereon offset to each other with respect to a circumference of the adapter sleeve.

7. The printing cylinder according to claim 6, wherein the offset of the lock-up slots on the circumference of the adapter sleeve is 90 degrees, 120 degrees or 180 degrees.

8. The printing cylinder according to claim 1, wherein the adapter sleeve consists of a metal and/or a plastic foam.

9. The printing cylinder according to claim 8, wherein the adapter sleeve is built up in layers.

10. The printing cylinder according to claim 8, wherein the adapter sleeve has intermediate stabilizing layers between foamed layers.

11. A method for operating a rotary web press, wherein a printing cylinder consists of at least one cylinder core and an adapter sleeve, wherein the adapter sleeve is installed onto the cylinder core, and wherein either a printing form in a shape of a sleeve or a printing plate is attached to the adapter sleeve before a printing process depending on a size of a print run.

12. The method according to claim 11, wherein the printing form is imaged either inside or outside the printing press.

13. A printing cylinder for a rotary web press, comprising:
a cylinder core;
an adapter sleeve disposed around the cylinder core; and
a printing form disposed on the adapter sleeve.

14. The printing cylinder according to claim 13, wherein the printing form is a sleeve.

15. The printing cylinder according to claim 13, wherein the printing form is a printing plate.

16. The printing cylinder according to claim 13, wherein the adapter sleeve is a foam material.

17. The printing cylinder according to claim 13, wherein the adapter sleeve includes a lock-up slot.

18. The printing cylinder according to claim 14, wherein the sleeve is an endless sleeve.

19. The printing cylinder according to claim 14, wherein the sleeve includes a weld seam.

20. The printing cylinder according to claim 13, wherein the adapter sleeve is disposed around an entire circumference of the cylinder core.
